(19) United States
(12) Patent Application Publication
(10) Pub. No.: US 2012/0064380 A1
(43) Pub. Date: Mar. 15, 2012

(54) RECHARGEABLE BATTERY

(76) Inventors: Sung-Bae Kim, Yongin-si (KR); Sang-Won Byun, Yongin-si (KR); Joong-Heon Kim, Yongin-si (KR); Jong-Seok Moon, Yongin-si (KR)

(21) Appl. No.: 13/009,776

(22) Filed: Jan. 19, 2011

(30) Foreign Application Priority Data
Sep. 14, 2010 (KR) 10-2010-0090063

(51) Int. Cl. H01M 2/10

(52) U.S. Cl. 429/66

(57) ABSTRACT

A rechargeable battery including an electrode assembly; a case having an opening and containing the electrode assembly; a cap plate sealing the opening of the case; an electrode terminal electrically connected to the electrode assembly and protruding outside the case; and an insulating member between the electrode assembly and the cap plate and adjacent the electrode terminal, the insulating member including an inclined portion facing the electrode assembly.

### CROSS-REFERENCE TO RELATED APPLICATION

This application claims priority to and the benefit of Korean Patent Application No. 10-2010-0090063 filed in the Korean Intellectual Property Office on Sep. 14, 2010, the entire content of which is incorporated herein by reference.

### BACKGROUND

1. Field

Aspects of embodiments of the present invention relate to a rechargeable battery.

2. Description of the Related Art

A rechargeable battery differs from a primary battery in that it can be repeatedly charged and discharged, while the latter makes the irreversible conversion of chemical energy to electrical energy. Low-capacity rechargeable batteries are used as the power supply for small electronic devices, such as cellular phones, notebook computers and camcorders, while high-capacity rechargeable batteries are used as the power supply for driving motors in hybrid vehicles and the like.

A high-power rechargeable battery using a non-aqueous electrolyte with a high energy density has been recently developed. For example, the high-power rechargeable battery is constructed with a high-capacity rechargeable battery having a plurality of rechargeable cells coupled to each other in series such that it can be used as the power supply for driving motors in electric vehicles requiring high power. The rechargeable battery may have a cylindrical shape or a prismatic shape.

Due to repeated charging and discharging or external impact, a gas is generated in the rechargeable battery and internal pressure is increased, and thus an electrode assembly wound in a jelly roll shape may be deformed. The deformed electrode assembly does not contact a case of the rechargeable battery due to an insulating member that functions as an insulator between the case and the electrode assembly.

However, when the deformed electrode assembly contacts a corner formed in the insulating member, the electrode assembly may be damaged.

In addition, when the electrode assembly is deformed, a space between a lower insulating member and the electrode assembly is decreased such that excessive pressure is applied to the electrode assembly by a lower assembly.

The above information disclosed in this Background section is only for enhancement of understanding of the background of the described technology and therefore it may contain information that does not form the prior art that is already known in this country to a person of ordinary skill in the art.

### SUMMARY

According to an aspect of embodiments of the present invention, a rechargeable battery having a lower insulating member can prevent or substantially prevent an electrode assembly deformed due to external impact or increase of internal pressure from being damaged and provide a space for deformation of the electrode assembly.

According to an exemplary embodiment, a rechargeable battery includes: an electrode assembly; a case having an opening and containing the electrode assembly; a cap plate sealing the opening of the case; an electrode terminal electrically connected to the electrode assembly and protruding outside the case; and an insulating member between the electrode assembly and the cap plate and adjacent the electrode terminal, the insulating member including an inclined portion facing the electrode assembly.

The inclined portion of the insulating member may include a rounded inclined side.

The inclined portion of the insulating member may include a flat inclined side.

The insulating member may further include a protruding portion extending from an end thereof.

The protruding portion may extend from a body portion of the insulating member and have a first thickness at a first end adjacent the body portion, the first thickness being less than a thickness of the body portion.

The protruding portion may have a second thickness at a second end opposite the first end, the second thickness being substantially the same as the first thickness.

The protruding portion may have a second thickness at a second end opposite the first end, the second thickness being less than the first thickness.

The insulating member may include a stepped portion at an end thereof, and a space may be formed between the cap plate and the stepped portion.

The rechargeable battery may further include a protecting member surrounding an external side of the electrode assembly corresponding to the insulating member.

The protecting member may include a tape.

The insulating member may include an elastic material.

According to an aspect of exemplary embodiments of the present invention, a lower insulating member can prevent or substantially prevent an electrode assembly deformed due to an increase of pressure in a case or external impact from being damaged when the lower insulating member contacts the electrode assembly.

### BRIEF DESCRIPTION OF THE DRAWINGS

The above and other features and advantages will become more apparent to those of ordinary skill in the art by describing in detail some exemplary embodiments of the present invention with reference to the attached drawings. Moreover, additional aspects and/or advantages of embodiments of the present invention are set forth in the following description and accompanying drawings, or may be obvious in view thereof to those skilled in the art.

FIG. 1 is a perspective view of a rechargeable battery according to an exemplary embodiment of the present invention.

FIG. 2 is a cross-sectional view of the rechargeable battery of FIG. 1, taken along the line II-II.

FIG. 3 is a partial exploded perspective view of the rechargeable battery of FIG. 1.

FIG. 4 is a partial cross-sectional view of the rechargeable battery of FIG. 3, taken along the line IV-IV.

FIG. 5 is a partial cross-sectional view of a rechargeable battery according to another exemplary embodiment of the present invention.

FIG. 6 is a partial exploded perspective view of a rechargeable battery according to another exemplary embodiment of the present invention.

FIG. 7 is a cross-sectional view of the rechargeable battery of FIG. 6, taken along the line VII-VII.

FIG. 8 is a partial cross-sectional view of a rechargeable battery according to another exemplary embodiment of the present invention.

FIG. 9 is a partial cross-sectional view of a rechargeable battery according to another exemplary embodiment of the present invention.

FIG. 10 is a partial cross-sectional view of a rechargeable battery according to another exemplary embodiment of the present invention.

FIG. 11 is a partial exploded perspective view of a rechargeable battery according to another exemplary embodiment of the present invention.

FIG. 12 is a partial cross-sectional view of the rechargeable battery of FIG. 11, taken along the line XII-XII.

Description of Reference Numerals Indicating
Some Elements in the Drawings

101, 102, 103, 104, 105, 106, 107: rechargeable battery

| | |
|---|---|
| 10: electrode assembly | |
| 11: first electrode | 12: second electrode |
| 13: separator | 21: first electrode terminal |
| 22: second electrode terminal | 26: case |
| 31: cap plate | 40: electrode current collector |
| 60, 70: lower insulating member | 261, 361, 461, 561, 661: body portion |
| 262, 362, 462, 562: protruding | |
| portion | |
| 662: stepped portion | |

### DETAILED DESCRIPTION

The present invention will be described more fully hereinafter with reference to the accompanying drawings, in which some exemplary embodiments of the invention are shown. However, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art. As those skilled in the art would realize, the described embodiments may be modified in various different ways, all without departing from the spirit or scope of the present invention. In the specification and drawings, like reference numerals designate like elements.

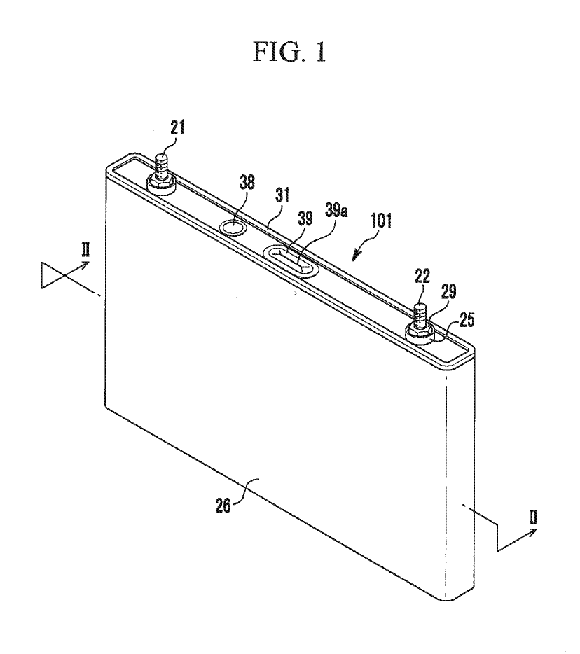

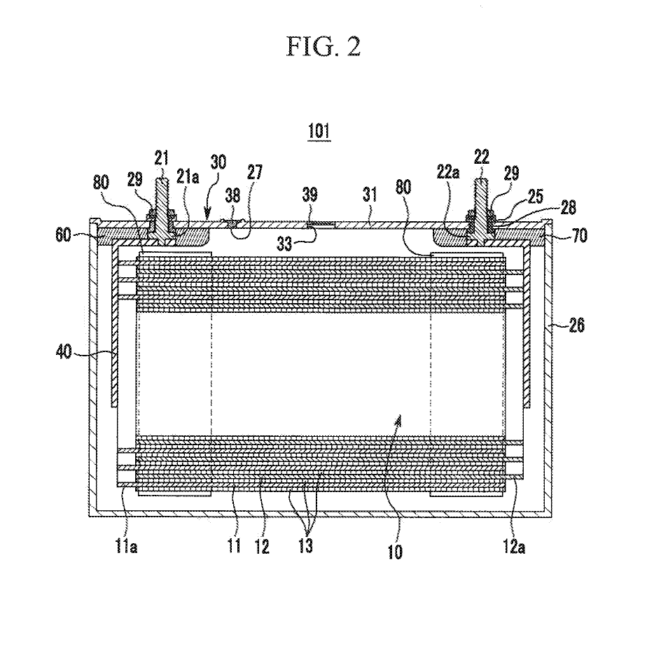

FIG. 1 is a perspective view of a rechargeable battery according to an exemplary embodiment of the present invention, and FIG. 2 is a cross-sectional view of the rechargeable battery of FIG. 1, taken along the line II-II.

Referring to FIG. 1 and FIG. 2, a rechargeable battery 101 according to an exemplary embodiment of the present invention includes an electrode assembly 10 spirally wound by interposing a separator 13 between a first electrode 11 and a second electrode 12, a case 26, a cap plate 31 where an emission hole 33 is formed, a vent plate 39 combined to one end of the emission hole 33, and lower insulating members 60 and 70 provided in the case 26.

For purposes of description, in an exemplary embodiment, the rechargeable battery 101 is described as a lithium ion rechargeable battery having a quadrangular shape. However, without being limited thereto, the present invention is applicable to various other types of batteries, such as a lithium polymer battery, a cylindrical battery, and the like. In addition, the first electrode 11 may be a negative electrode and the second electrode 12 may be a positive electrode, or the first electrode 11 may be a positive electrode and the second electrode 12 may be a negative electrode. However, the first electrode 11 and the second electrode 12 will be described without reference to polarity herein for ease of description.

The electrode assembly 10, in one embodiment, is formed in a jelly roll shape by spirally winding the first electrode 11, the second electrode 12, and the separator 13. The first electrode 11 and the second electrode 12 each include a respective current collector formed of a thin metal foil and an active material coated on the surface of the current collector. In addition, the first electrode 11 and the second electrode 12 may be divided into respective coated regions where the active material is coated over the current collector and uncoated regions 11a and 12a where the active material is not coated over the current collector. The coated regions form most of the first and second electrodes 11 and 12 in the electrode assembly 10, and the uncoated regions 11a and 12a are respectively disposed at both sides of the coated region.

However, embodiments of the present invention are not limited thereto, and in another embodiment, for example, the electrode assembly 10 may have a structure in which the first and second electrodes are formed with a plurality of sheets being stacked, interposing a separator therebetween.

The case 26, in one embodiment, is formed substantially in the shape of a cuboid, and has an opening at one side thereof. A cap assembly 30 includes the cap plate 31 covering the opening of the case 26, a first electrode terminal 21 protruding to the outside of the cap plate 31 and electrically connected with the first electrode 11, a second electrode terminal 22 protruding to the outside of the cap plate 31 and electrically connected with the second electrode 12, and the vent plate 39 having a notch 39a to be broken depending on a predetermined internal pressure level.

The cap plate 31 is formed with a thin plate, and combined to the opening of the case 26 to seal the opening. The cap plate 31 blocks the inside of the sealed case 26 from the outside thereof. In addition, the inside and the outside of the cap plate 31 may be connected with each other. For example, the cap plate 31 may include an electrolyte solution inlet 27 for injection of an electrolyte solution into the sealed case 26. After injection of the electrolyte solution, the electrolyte solution inlet 27 is sealed by a sealing cap 38.

The first and second electrode terminals 21 and 22 penetrate the cap plate 31, and, therefore, a first gasket 25 disposed in an upper portion of the cap plate 31 and a second gasket 28 disposed in a lower portion of the cap plate 31 insulate the cap plate 31 from the first and second electrode terminals 21 and 22.

The first and second electrode terminals 21 and 22, in one embodiment, are formed in the shape of a circular cylinder, and nuts 29 are provided at upper portions of the first and second electrode terminals 21 and 22 to support them therefrom, and screw threads are formed at the outer circumferences of the first and second electrode terminals 21 and 22 so as to be engaged with the nuts 29. Terminals flanges 21a and 22a are formed at lower portions of the first and second electrode terminals 21 and 22 to support them therefrom. When the nuts 29 are fastened to the first and second electrode terminals 21 and 22, the terminal flanges 21a and 22a and the nuts 29 press the first gasket 25 and the second gasket 28 such that first and second electrode terminals 21 and 22 and the cap plate 31 are sealed to each other. However, embodiments of the first and second electrode terminals 21 and 22 are not limited thereto, and in another embodiment, for example, the first and second electrode terminals 21 and 22 may be formed in the shape of a plate type terminal (not shown) combined with the cap plate 31 or a terminal plate through a rivet.

In one embodiment, a protecting member 80 surrounding the external side of a portion of the electrode assembly 10 corresponding to the lower insulating members 60 and 70 surrounds the electrode assembly 10. The protecting member 80 may be a tape that surrounds the electrode assembly 10. Thus, the electrode assembly 10 can be prevented or substantially prevented from being broken even though it is deformed due to external impact. Here, the tape of the protecting member 80 may be formed with an insulating material.

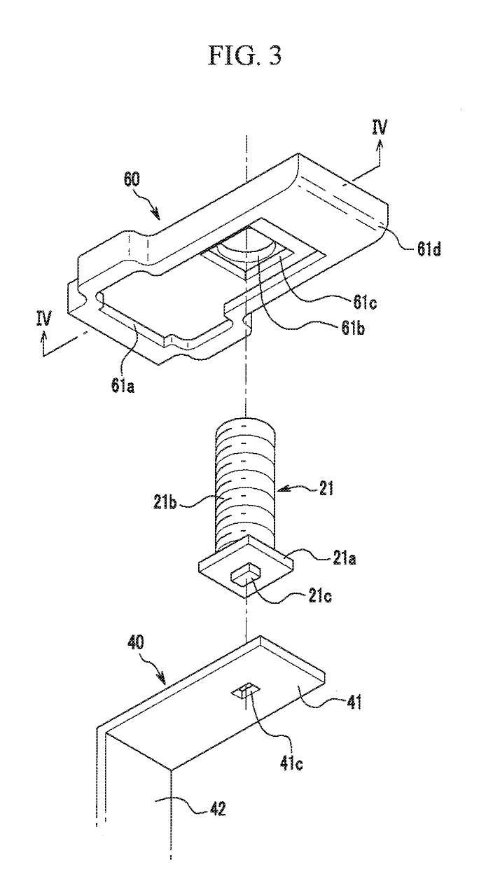

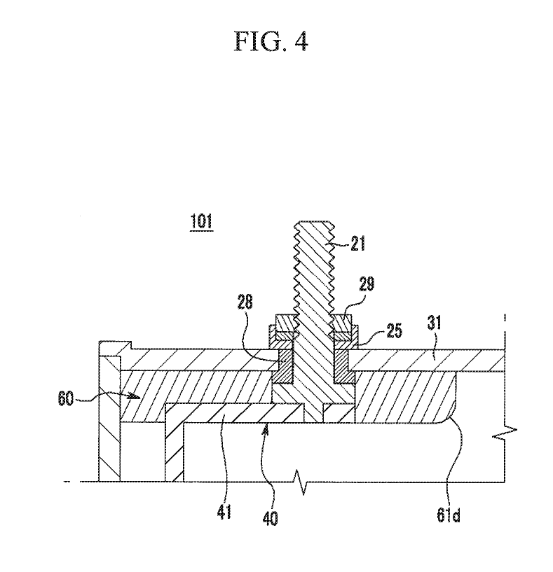

FIG. 3 is a partial exploded perspective view of the rechargeable battery 101, and FIG. 4 is a partial cross-sectional view of the rechargeable battery 101, taken along the line IV-IV of FIG. 3.

Referring to FIG. 3 and FIG. 4, the lower insulating member 60 is provided for insulation between the terminal flange 21a and the cap plate 31. The terminal flange 21a and a first electrode current collecting member 40 are inserted into a groove formed in the lower insulating member 60 disposed under the cap plate 31. The lower insulating member 60 functions to insulate the first electrode current collecting member 40 and the first electrode terminal 21 with the cap plate 31, and is inserted between the terminal flange 21a and the cap plate 31 and then stably fixed.

As shown in FIG. 3, in one embodiment, the first electrode terminal 21 includes a terminal rod 21b protruding from the terminal flange 21a and having an external circumferential surface which is threaded, and a support protrusion 21c protruding toward the bottom of the case 26 from the bottom of the terminal flange 21a.

In addition, the first electrode current collecting member 40, in one embodiment, includes a terminal joining portion 41 where a support hole 41c is formed and into which the support protrusion 21c of the first electrode terminal 21 is inserted, and an electrode joining portion 42 bent from the terminal joining portion 41 and attached to the electrode assembly 10, such as by welding.

In addition, the lower insulating member 60 is formed with an insulating material. Thus, a side of the lower insulating member 60 facing a lower side of the cap plate 31 is provided close to the lower side of the cap plate 31 so as to prevent or substantially prevent a current from flowing between the cap plate 31 and the electrode assembly 10. In embodiments of the present invention, the size of the lower insulating member 60 may be varied according to the number of electrode assemblies 10 received in the case 26, and the lower insulating member 60 may include an elastic material that can absorb external impact.

Referring to FIG. 3 and FIG. 4, in one embodiment, the lower insulating member 60 is formed in the shape of a thick plate and includes a terminal hole 61b formed therein (e.g., at the right side thereof), a flange groove 61c, and a joining groove 61a formed at a side of the lower insulating member 60 facing the first electrode current collecting member 40.

In one embodiment, the first electrode terminal 21 is inserted in the terminal hole 61b, the terminal flange 21a is fixed in the flange groove 61c, the terminal joining portion 41 of the first electrode current collecting member 40 is inserted into the joining groove 61a, and the support protrusion 21c is inserted into the support hole 41c and is attached thereto, such as by welding.

Thus, the lower insulating member 60 insulates the cap plate 31 and the first electrode current collecting member 40 and simultaneously stably fixes the lower insulating member 60 in the case 26.

In one embodiment, the lower insulating member 60 includes an inclined portion facing the electrode assembly 10, such as an inclined side at a lower corner 61d at the right side of the lower insulating member 60 facing the electrode assembly 10. In one embodiment, the inclined side of the corner 61d may be rounded. The electrode assembly 10 partially contacts the corner 61d including the rounded inclined side when an experiment (e.g., a drop test) for measuring durability of the rechargeable battery 101 is performed, and the corner 61d can prevent or substantially prevent the electrode assembly 10 from being damaged. In addition, when the electrode assembly 10 expands due to gas generated from the inside of the electrode assembly 10 that repeatedly performs charging and discharging and thus partially contacts the corner 61d including the rounded inclined side at the lower insulating member 60, the corner 61d can prevent or substantially prevent the contacting portion of the electrode assembly 10 from being damaged.

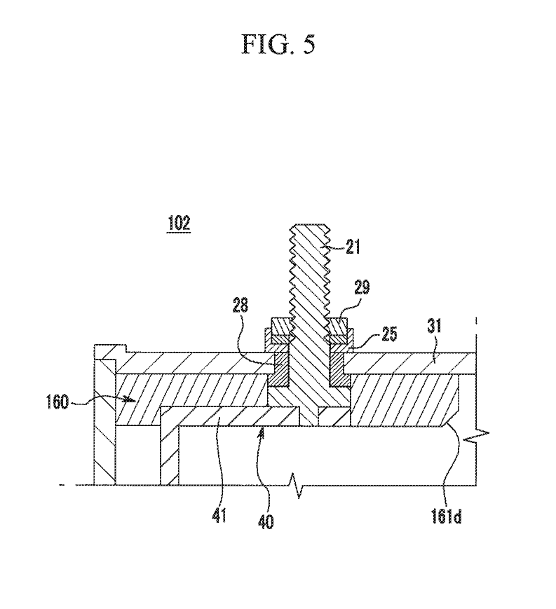

FIG. 5 is a partial cross-sectional view of another exemplary embodiment of the present invention that is similar to the embodiment shown in FIGS. 3 and 4.

Referring to FIG. 5, a rechargeable battery 102 according to another exemplary embodiment is the same as the rechargeable battery 101 described above, except for a lower insulating member 160, and therefore a description of the same components and structures will not be repeated. In addition, a size and material of the lower insulating member 160 may be the same as the lower insulating member 60, and therefore no further description will be provided.

As shown in FIG. 5, an inclined side at a lower right side of the lower insulating member 160, facing the electrode assembly 10 may be flat. A lower corner 161d including the flat inclined side can provide a structure that can prevent or substantially prevent the electrode assembly 10 deformed due to internal pressure variation in the rechargeable battery 102 or external impact from being damaged by the lower insulating member 160.

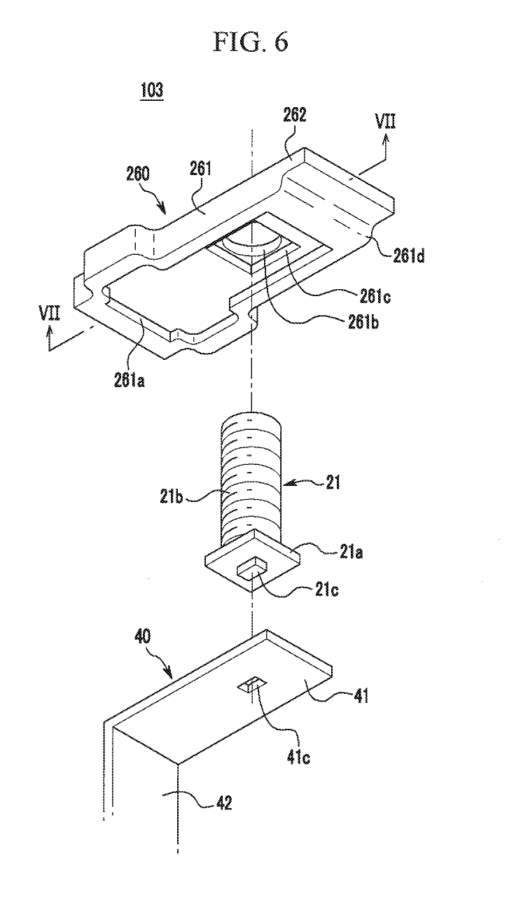

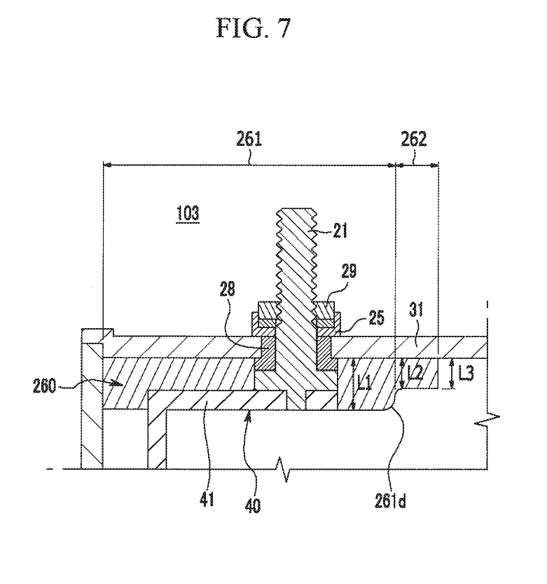

FIG. 6 is a partial exploded perspective view of a rechargeable battery according to another exemplary embodiment of the present invention, and FIG. 7 is a partial cross-sectional view taken along the line VII-VII of FIG. 6.

Referring to FIG. 6 and FIG. 7, a rechargeable battery 103 according to another exemplary embodiment of the present invention is the same as the rechargeable battery 101 described above, except for a lower insulating member 260, and therefore a description of the same components and structures will not be repeated. In addition, an inclined side of a corner 261d including a rounded inclined side of the lower insulating member 260 is the same as the inclined side of the corner 61d including the rounded inclined side in the rechargeable battery 101, and therefore further description of this aspect will not be provided. In addition, the lower insulating member 260 is the same as the lower insulating member 60 of the rechargeable battery 101 in material and size, excluding the thickness, and therefore further description will not be provided.

Referring to FIG. 6, the lower insulating member 260 includes a body portion 261 fixed to the first electrode terminal 21 and a protruding portion 262 extending from a side (e.g., the right side) of the body portion 261.

Here, the body portion 261 of the lower insulating member 260 has a first thickness L1, and the protruding portion 262 has a second thickness L2 at a portion adjacent the body portion 261, or where extension of the protruding portion 262 begins, and a third thickness L3 at a portion where the extension is ended (i.e. an end of the protruding portion 262 opposite the end adjacent the body portion 261). The thicknesses L1, L2, and L3 are measured in a direction perpendicular to the cap plate 31.

In one embodiment, the second thickness L2 and the third thickness L3 in the body portion 262 of the lower insulating member 260 are equal or substantially the same as one another.

In addition, the protruding portion 262 extends to the right side of FIG. 6 from a portion separated from an upper portion of an inclined side of the corner 261d including a rounded inclined side of the body portion 261.

Thus, the second and third thicknesses L2 and L3 of the protruding portion 262 are thinner than the first thickness L1 of the body portion 261, and therefore a space formed between the protruding portion 262 and the electrode assembly 10 is larger than a space between the body portion 261 and the electrode assembly 10.

When a test (e.g., a drop test) for measuring durability of the rechargeable battery 103 is performed, the space between the protruding portion 262 and the electrode assembly 10 may receive a deformed portion of the electrode assembly 10, not contacting the corner 261d including the rounded inclined side of the lower insulating member 260. In addition, the space between the protruding portion 262 and the electrode assembly 10 may receive a deformed portion of the electrode assembly 10, not contacting the corner 261d including the rounded inclined side of the lower insulating member 260 when the electrode assembly 10 repeatedly charging and discharging expands due to an internal gas generated from the electrode assembly 10.

The protruding portion 262 provides an insulating function to block a current flowing between the cap plate 31 and the electrode assembly 10 and simultaneously provides a buffer space for absorbing impact when a portion of the electrode assembly 10 corresponding to the protruding portion 262 is deformed due to external impact.

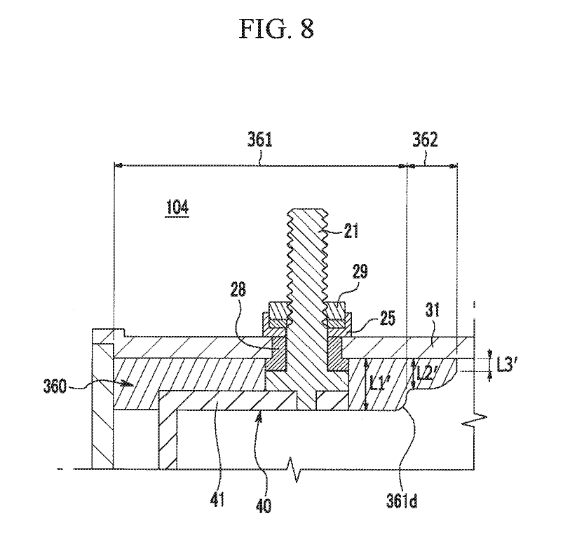

FIG. 8 is a partial cross-sectional view of another exemplary embodiment of the present invention.

Referring to FIG. 8, a rechargeable battery 104 according to another exemplary embodiment is the same as the rechargeable battery 103 described above, except for a lower insulating member 360, and therefore a description of the same components and structures will not be repeated. In addition, an inclined side of a corner 361d including a rounded inclined side of the lower insulating member 360 is the same as the inclined side of the corner 261d including the rounded inclined side of the lower insulating member 260 described above, and therefore, further description thereof will not be provided. Further, the lower insulating member 360 is the same as the lower insulating member 260 in material and size, excluding the thickness, and therefore, further description thereof will not be provided.

As shown in FIG. 8, a body portion 361 of the lower insulating member 360 includes a first thickness L1′. In addition, a protruding portion 362 of the lower insulating member 360 has a second thickness L2′ at a portion where extension starts from the body portion 361 and a third thickness L3″ at a portion where the extension ends. The thicknesses L1, L2′, and L3′ are measured in a direction perpendicular to the cap plate 31. In one embodiment, the second thickness L2′ of the protruding portion 362 is less than the first thickness L1′ of the body portion 361.

FIG. 8 illustrates that the protruding portion 362 extends to the right side from a portion separated to an upper portion of the inclined side of the corner 361d including the rounded inclined side of the body portion 361.

In one embodiment, the second thickness L2′ is greater than the third thickness L3′, and therefore a space between the protruding portion 362 and the electrode assembly 10 is larger than the space between the protruding portion 262 and the electrode assembly 10 in the rechargeable battery 103.

Thus, compared to the rechargeable battery 103, the space between the protruding portion 362 and the electrode assembly 10 can be larger for providing a buffer space where a portion of the electrode assembly 10 corresponding to the protruding portion 362 is deformed due to external impact, and the impact can be absorbed.

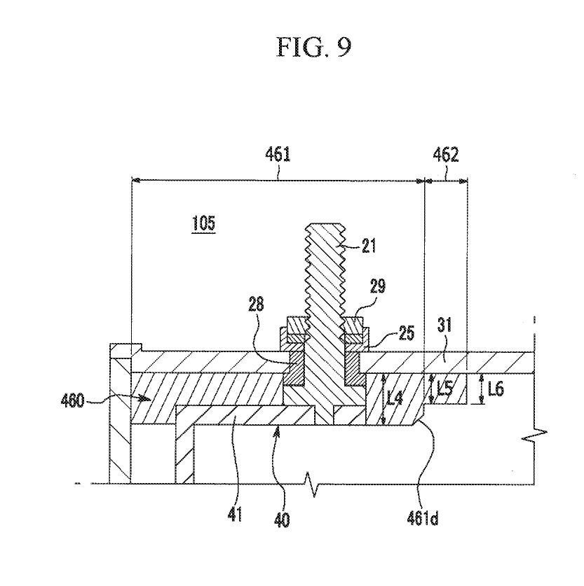

FIG. 9 is a partial cross-sectional view of a rechargeable battery according to another exemplary embodiment of the present invention.

Referring to FIG. 9, a rechargeable battery 105 according to another exemplary embodiment is the same as the rechargeable battery 103 described above, except for a lower insulating member 460, and therefore a description of the same components and structures will not be repeated.

Referring to FIG. 9, the lower insulating member 460 includes a body portion 461 fixed to the first electrode terminal 21 and a protruding portion 462 extending from the body portion 461.

The body portion 461 of the lower insulating member 460 has a fourth thickness L4 measured in a direction perpendicular to the cap plate 31. In addition, a lower corner 461d at the right side of the body portion 461 is flat and inclined. When a test (e.g., a drop test) for measuring durability of the rechargeable battery 105 is performed and a portion of the electrode assembly 10 contacts the corner 461d, the corner 461d formed in the lower insulating member 460 can prevent or substantially prevent the portion of the electrode assembly 10 from being damaged. In addition, when the electrode assembly 10 expands due to an internal gas generated from the electrode assembly 10 that repeatedly performs charging and discharging and the electrode assembly 10 partially contacts the lower insulating member 460, the inclined side of the flat inclined corner 461d can prevent or substantially prevent the contacting portion of the electrode assembly 10 from being damaged.

In FIG. 9, the protruding portion 462 of the lower insulating member 460 extends at the right side of the lower insulating member 460.

The body portion 461 of the lower insulating member 460 has a fourth thickness L4, and the protruding portion 462 has a fifth thickness L5 at a portion where extension starts from the body portion 461 and a sixth thickness L6 at a portion where the extension ends. The thicknesses L5 and L6 are measured in a direction perpendicular to the cap plate 31.

In one embodiment, the fifth thickness L5 of the protruding portion 462 of the lower insulating member 460 may be substantially the same as the sixth thickness L6.

In FIG. 9, the protruding portion 462 is extended to the right side from a portion separated to an upper portion of a flat inclined corner 261d of the body portion 461.

Thus, a space between the protruding portion 462 and the electrode assembly 10 is larger than a space between the body portion 461 and the electrode assembly 10.

When a test (e.g., a drop test) for measuring durability of the rechargeable battery 105 is performed, the space formed between the protruding portion 462 and the electrode assembly 10 may receive a deformed portion of the electrode assembly 10, not contacting an inclined side of the corner 461d including the flat inclined side of the lower insulating member 460. In addition, the space formed between the protruding portion 462 and the electrode assembly 10 may receive a deformed portion of the electrode assembly 10, not contacting the inclined side of the corner 461d including the flat inclined side of the lower insulating member 460 when the electrode assembly 10 that repeatedly performs charging and discharging expands due to an internal gas generated from the electrode assembly 10.

The protruding portion 462 provides an insulating function to block a current flowing between the cap plate 31 and the electrode assembly 10 and simultaneously provides a buffer space for absorbing impact when a portion of the electrode assembly 10 corresponding to the protruding portion 462 is deformed due to external impact.

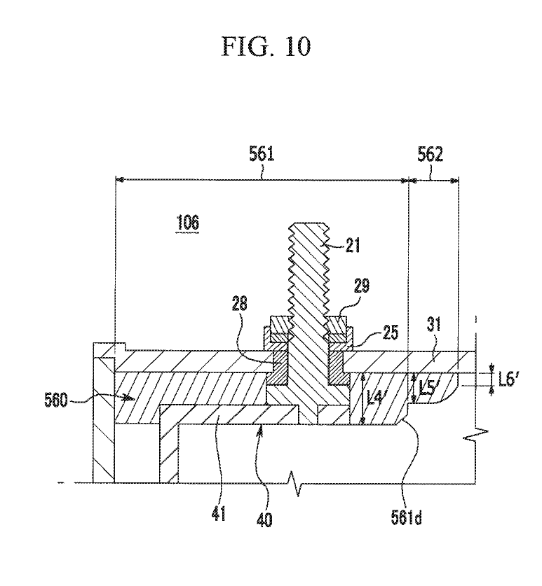

FIG. 10 is a partial cross-sectional view of another exemplary embodiment of the present invention.

Referring to FIG. 10, a rechargeable battery 106 according to another exemplary embodiment is the same as the rechargeable battery 105 described above, except for a lower insulating member 560, and therefore a description of the same components and structures will not be repeated.

In addition, an inclined side of a corner 561d including a flat inclined side of the lower insulating member 560 is the same as the flat inclined corner 461d of the lower insulating member 460, and therefore further description thereof will not be provided. Further, the lower insulating member 560 may be the same as the lower insulating member 460 in material and size, excluding the thickness, and therefore further description thereof will not be provided.

Referring to FIG. 10, the lower insulating member 560 includes a body portion 561 fixed to the first electrode terminal 21 and a protruding portion 562 extending from a side (e.g., the right side) of the body portion 561.

As shown in FIG. 10, the body portion 561 of the lower insulating member 560 has a fourth thickness L4′. In addition, the body portion 561 of the lower insulating member 560 has a fifth thickness L5′ at a portion where extension starts from the body portion 561 and a sixth thickness at a portion L6′ where the extension ends. The thicknesses L4′, L5′, and L6′ are measured in a direction perpendicular to the cap plate 31.

In one embodiment, the thickness L5′ of the protruding portion 562 of the lower insulating member 560 is greater than the sixth thickness L6′.

In FIG. 10, the protruding portion 562 is extended to the right side from a portion separated to an upper side from the inclined side of the corner 561d including a flat inclined side of the body portion 561.

In one embodiment, the fifth thickness L5′ is greater than the sixth thickness L6′. Thus, a space between the protruding portion 562 and the electrode assembly 10 is larger than a space between the protruding portion 462 and the electrode assembly 10 of the rechargeable battery 105.

Thus, compared to the rechargeable battery 105, the space between the protruding portion 562 and the electrode assembly 10 can be larger for providing a buffer space where a portion of the electrode assembly 10 corresponding to the protruding portion 562 is deformed due to external impact and the impact can be absorbed.

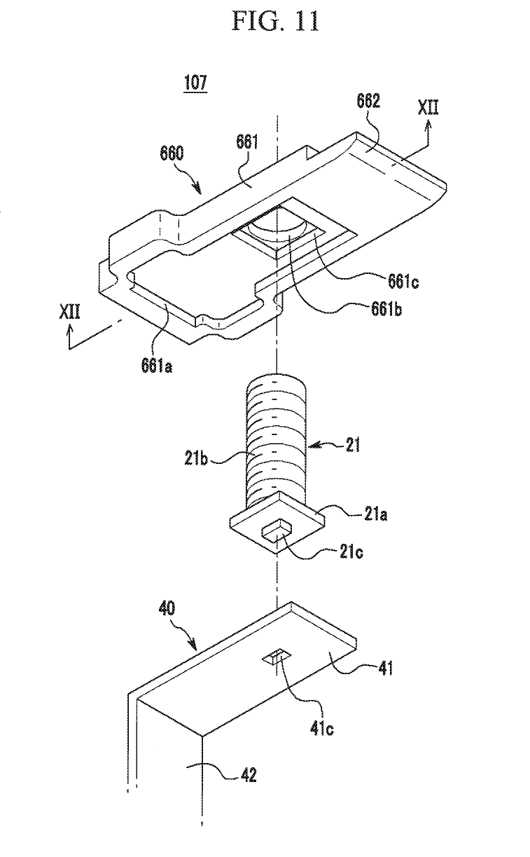

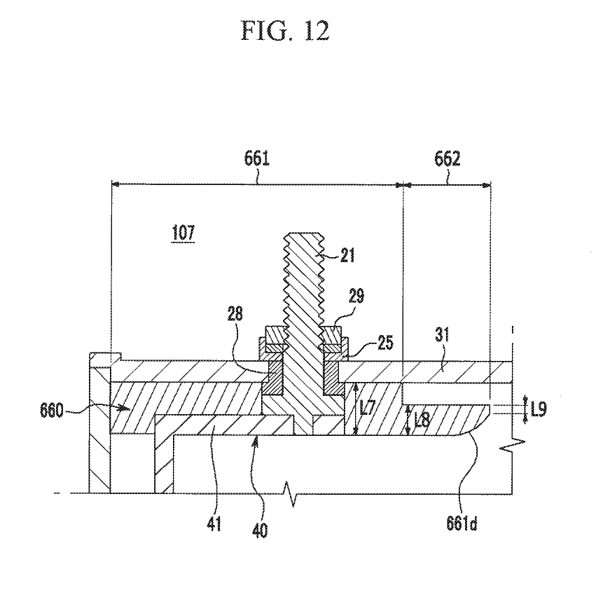

FIG. 11 is a partial exploded perspective view of a rechargeable battery according to another exemplary embodiment of the present invention, and FIG. 12 is a partial cross-sectional view, taken along the line XII-XII.

Referring to FIG. 11 and FIG. 12, a rechargeable battery 107 according to another exemplary embodiment is the same as the rechargeable battery 101 described above, except for a lower insulating member 660, and therefore a description of the same components and structures will not be repeated.

In addition, a joining groove 661a, a terminal hole 661b, and a flange groove 661c included in the lower insulating member 660 are the same as the joining groove 61a, the terminal hole 61b, and the flange groove 61c of the lower insulating member 60, and therefore further description thereof will not be provided. Further, the lower insulating member 660 may be the same as the lower insulating member 60 in material and size, excluding the thickness, and therefore further description thereof will not be provided.

Referring to FIG. 11 and FIG. 12, the lower insulating member 660 includes a body portion 661 fixed to the first electrode terminal 21 and a stepped portion 662 formed at one end of the body portion 661 and facing the cap plate 31.

The body portion 661 of the lower insulating member 660 has a seventh thickness L7 measured in a direction perpendicular to the cap plate 31.

In addition, the stepped portion 662 of the lower insulating member 660 has an eighth thickness L8 at an end of the stepped portion 662 that is adjacent the body portion 661 and a ninth thickness L9 at an opposite end of the stepped portion 662. The thicknesses L8 and L9 are measured in a direction perpendicular to the cap plate 31.

In one embodiment, the eighth thickness L8 of the stepped portion 662 of the lower insulating member 660 is greater than the ninth thickness L9. However, in another embodiment, the eighth thickness L8 and the ninth thickness L9 may be the same or substantially the same.

In one embodiment, the eighth thickness L8 of the stepped portion 662 is less than the seventh thickness L7 of the body portion 661, and a space is formed between the stepped portion 662 and the cap plate 31 when the lower insulating member 660 is closely attached to or abutting the cap plate 31.

In FIG. 12, the space between the stepped portion 662 and the cap plate 31 receives the elastic stepped portion 662 deformed by an upward pressure due to deformation of the electrode assembly 10 from a test (e.g., a drop test) for measuring durability of the rechargeable battery 107 or an increase of internal pressure.

Thus, the stepped portion 662 provides an insulating function to block a current flowing between the cap plate 31 and the electrode assembly 10 and simultaneously provides a buffer space for absorbing impact when a portion of the electrode assembly 10 corresponding to the stepped portion 662 is deformed due to external impact.

While this invention has been described in connection with what are presently considered to be some exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly;
a case having an opening and containing the electrode assembly;
a cap plate sealing the opening of the case;
an electrode terminal electrically connected to the electrode assembly and protruding outside the case; and
an insulating member between the electrode assembly and the cap plate and adjacent the electrode terminal, the insulating member comprising an inclined portion facing the electrode assembly.

2. The rechargeable battery of claim 1, wherein the inclined portion of the insulating member comprises a rounded inclined side.

3. The rechargeable battery of claim 2, further comprising a protecting member surrounding an external side of the electrode assembly corresponding to the insulating member.

4. The rechargeable battery of claim 3, wherein the protecting member comprises a tape.

5. The rechargeable battery of claim 1, wherein the inclined portion of the insulating member comprises a flat inclined side.

6. The rechargeable battery of claim 5, further comprising a protecting member surrounding an external side of the electrode assembly corresponding to the insulating member.

7. The rechargeable battery of claim 1, wherein the insulating member further comprises a protruding portion extending from an end thereof.

8. The rechargeable battery of claim 7, further comprising a protecting member surrounding an external side of the electrode assembly corresponding to the insulating member.

9. The rechargeable battery of claim 7, wherein the protruding portion extends from a body portion of the insulating member and has a first thickness at a first end adjacent the body portion, the first thickness being less than a thickness of the body portion.

10. The rechargeable battery of claim 9, further comprising a protecting member surrounding an external side of the electrode assembly corresponding to the insulating member.

11. The rechargeable battery of claim 9, wherein the protruding portion has a second thickness at a second end opposite the first end, the second thickness being substantially the same as the first thickness.

12. The rechargeable battery of claim 11, further comprising a protecting member surrounding an external side of the electrode assembly corresponding to the insulating member.

13. The rechargeable battery of claim 9, wherein the protruding portion has a second thickness at a second end opposite the first end, the second thickness being less than the first thickness.

14. The rechargeable battery of claim 13, further comprising a protecting member surrounding an external side of the electrode assembly corresponding to the insulating member.

15. The rechargeable battery of claim 1, wherein the insulating member comprises a stepped portion at an end thereof, a space being formed between the cap plate and the stepped portion.

16. The rechargeable battery of claim 15, further comprising a protecting member surrounding an external side of the electrode assembly corresponding to the insulating member.

17. The rechargeable battery of claim 15, wherein the insulating member comprises an elastic material.

18. The rechargeable battery of claim 1, further comprising a protecting member surrounding an external side of the electrode assembly corresponding to the insulating member.

19. The rechargeable battery of claim 18, wherein the protecting member comprises a tape.

20. The rechargeable battery of claim 1, wherein the insulating member comprises an elastic material.
